(19) United States
(12) Patent Application Publication
(10) Pub. No.: US 2024/0370429 A1
(43) Pub. Date: Nov. 7, 2024

(54) GENERAL PURPOSE SQL REPRESENTATION MODEL

(71) Applicant: Oracle International Corporation, Redwood Shores, CA (US)

(72) Inventors: Aneesh Dahiya, Zurich (CH); Matteo Casserini, Zurich (CH); Marija Nikolic, Zurich (CH); Milos Vasic, Zurich (CH); Samuele Meta, Zurich (CH); Nikola Milojkovic, Dietikon (CH); Felix Schmidt, Baden-Dattwil (CH)

(21) Appl. No.: 18/143,776

(22) Filed: May 5, 2023

(51) Int. Cl. G06F 16/2452; G06N 3/0455; G06N 3/08

(52) U.S. Cl. CPC G06F 16/24522; G06N 3/0455; G06N 3/08

(57) ABSTRACT

In an embodiment, a computer generates sentence fingerprints that represent respective pluralities of similar database statements. Based on the sentence fingerprints, an artificial neural network is trained. After training the artificial neural network on a large corpus of fingerprinted database statements, the artificial neural network is ready to be used for zero-shot transfer learning to a downstream task in training. Database statement fingerprinting also anonymizes literal values in raw SQL statements. The trained artificial neural network can be safely reused without risk of disclosing sensitive data in the artificial neural network's vocabulary. After training, the artificial neural network infers a fixed-size encoded database statement from a new database statement. Based on the fixed-size encoded database statement, the new database statement is detected as anomalous, which increases database security and preserves database throughput by not executing the anomalous database statement.

### FIELD OF THE INVENTION

The present invention relates to natural language processing (NLP). To facilitate detection of anomalous database statements, an artificial neural network (ANN) is trained to infer an encoded database statement from a sentence fingerprint that represents many similar database statements.

### BACKGROUND

The field of machine learning (ML) has powerful tools and algorithms that automate decisions in a data driven way. ML models learn to make these decisions based on historical data by optimizing a cost or a loss function. This enables ML models to make informed predictions on previously unseen data.

Although ML in the context of database systems has unrealized potential for anomalous activity detection and database workload optimization, the state of the art uses rule-based algorithms which rely on knowledge of domain experts.

One of the main challenges of using any ML approach is generating an appropriate representation for the input and output data. This is because most ML models ingest and return encoded data, and state of the art feature engineering is not well suited for complex data. For example, structured query language (SQL) queries may require special transformations. A technical problem with using state of the art encodings, such as one hot, to encode SQL queries is that, depending upon the size of vocabulary, encodings can become huge. This can require more processor and memory resources. One hot encoding loses accuracy if previously unseen data contains any word that was not encountered during training.

A state of the art pretrained natural language processing (NLP) model is accurate only if previously unseen input is natural language. SQL and other formal computer languages are not natural language. Natural language pretraining and inferencing for formal computer languages are somewhat incompatible in the state of the art, which decreases accuracy and increases training time.

### BRIEF DESCRIPTION OF THE DRAWINGS

In the drawings:

FIG. 1 is a block diagram that depicts an example computer that trains an artificial neural network (ANN) to infer an encoded database statement from a sentence fingerprint that represents a database statement;

FIG. 2 is a flow diagram that depicts an example computer process to train an ANN to infer an encoded database statement from a sentence fingerprint that represents a database statement;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein is novel natural language processing (NLP) for database security. To facilitate detection of anomalous database statements, an artificial neural network (ANN) is trained to infer an encoded database statement from a sentence fingerprint that represents many similar database statements.

This approach represents database statements numerically using NLP encoding techniques. These numerical representations can be used to train and operate any ML models that accept numerical input. Encoding herein can capture rich structured query language (SQL) context and semantics to increase accuracy and decrease training duration across a variety of downstream applications. For example, a downstream application may be anomaly detection, classification, or numeric regression such as (e.g. threat) scoring. Herein is database statement fingerprinting that accelerates training and increases accuracy.

NLP models herein learn SQL statement representation and train solely on fingerprints for SQL statements. This does not entail query planning and does not use a query plan, which means that a new database statement can be detected as anomalous before query planning and thus avoid query planning. Avoiding query planning conserves processor time and memory space.

The NLP models are trained on a corpus of SQL statements in a self-supervised way that can use an unlabeled corpus. In an embodiment, NLP training minimizes skip-gram loss. The objective of the model is to predict missing tokens in a context when given another token in the context. For example, a query in the training corpus may be: SELECT name FROM table1

In that case, the NLP model trains to predict “SELECT”, “name” and “table1” from the input word “FROM”. This enables the NLP model to learn the semantic and syntactic resemblance of a word from the context in the training data. The NLP model may be trained exclusively on SQL statements that have a decreased vocabulary that increases accuracy, decreases training duration, and decreases memory consumption while inferencing in a production environment. This can capture the variability of tokens in the SQL vocabulary with small embedding vectors as opposed to large embeddings needed to capture complexity of natural prose's much larger vocabulary.

Database statement fingerprinting for representation learning acts as a denoiser which encourages ML models to learn more general embeddings and be more compute and memory efficient. Increased accuracy and accelerated training are benefits of database statement fingerprinting that also apply to (e.g. trainable) downstream tasks such as anomaly detection.

Representation models trained on a large corpus of fingerprinted database statements are, after training, ready to be used for zero-shot transfer learning to a downstream task in training. Database statement fingerprinting also anonymizes literal values in raw SQL statements. This means models trained on fingerprinted SQL statements from one dataset can be safely used on other use cases without risk of sensitive data being disclosed in the model vocabulary.

In an embodiment, a computer generates sentence fingerprints that represent respective pluralities of similar database statements. Based on the sentence fingerprints, an artificial neural network is trained. After training, the artificial neural network infers a fixed-size encoded database statement from a new database statement. Based on the fixed-size encoded database statement, the new database statement is detected as anomalous, which increases database security and preserves database throughput by not executing the anomalous database statement.

### 1.0 Example Computer

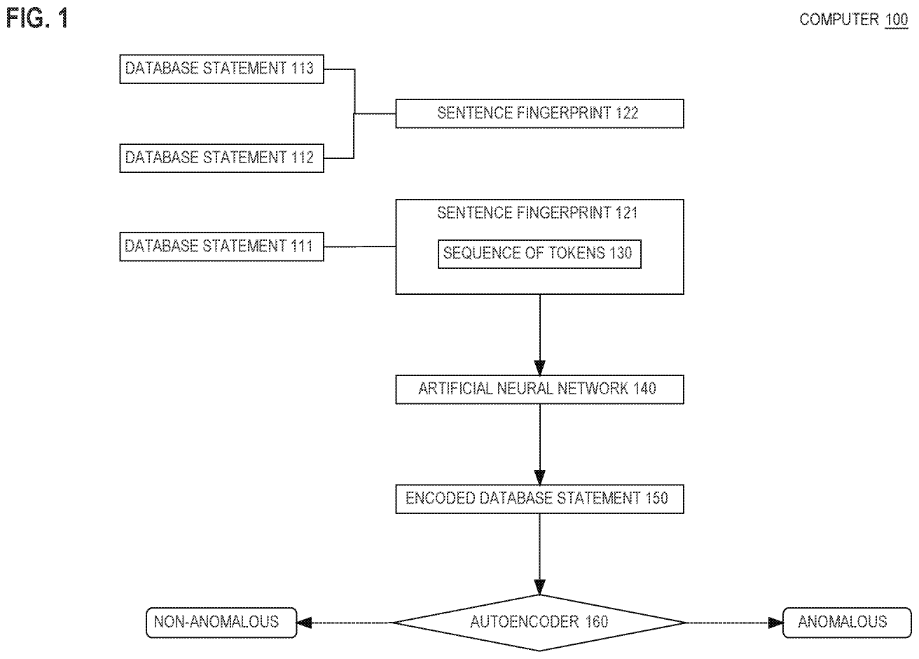

FIG. 1 is a block diagram that depicts an example computer 100. In an embodiment, artificial neural network (ANN) 140 is trained to infer encoded database statement 150 from sentence fingerprint 121 that represents database statement 111. Computer 100 may be one or more of a rack server such as a blade, a personal computer, a mainframe, or a virtual computer.

### 1.1 Database Statement Normalization

To train artificial neural network 140, computer 100 may use a large training corpus that consists of many database statements, including database statements 111-113. Database statement 111 may specify create read update delete (CRUD) or query by example (QBE). Database statement 111 may be a relational statement for a relational database. Database statement 111 may conform to a database language such as structured query language (SQL). For example, database statement 111 may conform to a data query language (DQL), a data manipulation language (DML), or a data control language (DCL).

Database statement 111 may consist of text that computer 100 tokenizes as sequence of tokens 130. For example, delimiter characters such as whitespace and punctuation may separate two words. Sequence of tokens 130 may be adjusted to normalize whitespace (including line breaks within database statement 111), decapitalize letters, and replace numbers (i.e. numeric literals) and quoted (i.e. text) literals with a predefined universal wildcard symbol, token, or character. The following is an example SQL statement that may be database statement 111: SELECT * From Orders where social=999000000 and when >=“Jan. 1, 2021”

The number and the quoted date are literals that normalization replaces with a question mark character that is used twice as a universal wildcard token in the following twelve tokens that are a comma-separated normalized sequence of tokens 130 for the above example SQL statement: select, *, from, orders, where, social, =, ?, and, when, >=, ?

### 1.2 Sentence Fingerprint

Sequence of tokens 130 may be stored as a vector of tokens or as a text string that concatenates the tokens separated by individual space characters. Normalized sequence of tokens 130 is operated as sentence fingerprint 121 that is not specific to an individual database statement.

For example, sentence fingerprint 122 represents multiple database statements 112-113 that are textually distinct before normalization and indistinguishable after normalization. In other words, both database statements 112-113 normalize to a same normalized sequence of tokens, which is the sequence of tokens in sentence fingerprint 122. In that way normalization achieves generalization, and sentence fingerprint 122 is a generalization of database statements 112-113. In an example not shown, both of sentence fingerprints 121-122 generalize respective multiple database statements.

Normalization also achieves anonymization because normalization removes identifying information. The above comma-separated sequence of tokens 130 is anonymous, and inclusion of sequence of tokens 130 in a training corpus does not introduce private data. For example, a training corpus may contain sentence fingerprints 121-122 instead of containing database statements 111-113. Thus, sentence fingerprints 121-122 effectively anonymize (i.e. increases security) and compress the training corpus to require less storage space. In embodiments, the training corpus consists essentially of database statements or sentence fingerprints that represent database statements.

From the training corpus, sentence fingerprints 121-122 are retrieved or generated (i.e. from database statements 111-113). Sentence fingerprints 121-122 are unlabeled training inputs that artificial neural network 140 accepts as training input. Sentence fingerprints 121-122 are variable (i.e. not fixed) sized because database statements 111-113 and sequence of tokens 130 are not fixed size.

### 1.3 Encoded Database Statement

Because autoencoder 160 only accepts a fixed-size feature vector, artificial neural network 140 infers encoded database statement 150 from variable sized sentence fingerprint 121. Encoded database statement 150 is fixed size and may be used as the feature vector that autoencoder 160 accepts. In a bidirectional encoder representations from transformers (BERT) embodiment, encoded database statement 150 is contextual based on the ordering of tokens in sequence of tokens 130. In a FastText embodiment, encoded database statement 150 is not contextual and is not based on the ordering of tokens in sequence of tokens 130. BERT and FastText are neural networks or multiple neural layers that artificial neural network 140 may contain.

In an embodiment, artificial neural network 140 contains an implementation of BERT that may be trained or, if pretrained, may be fine tuned based on the training corpus. In an embodiment (e.g. BERT), artificial neural network 140 does not comprise an autoencoder, a recurrent neural network, nor a long short-term memory.

In an embodiment, operation of artificial neural network 140 does not receive, process, nor generate subwords, which are less than a whole word. In that case, tokens (e.g. words) are atomic, which means that a token or word should not be decomposed into parts such as subwords. For example for SQL, keyword “SELECT” and an identifier “Selection” do not have subwords and do not have a (i.e. subword) token in common.

In an embodiment, the normalized (i.e. anonymized and decapitalized) training corpus has a vocabulary of at most a thousand tokens, including punctuation. This small vocabulary accelerates training of artificial neural network 140 and accelerates training of autoencoder 160.

### 1.4 Autoencoder as Trainable Downstream Model

Autoencoder 160 is an example application that is downstream of artificial neural network 140. Other downstream applications may use a component other than autoencoder 160. In this example, autoencoder 160 is an anomaly detector that detects whether encoded database statement 150 is anomalous or non-anomalous as shown.

Autoencoder 160 is trainable. Machine learning models 140 and 160 may be trained together with one training corpus or may be separately trained with separate training corpuses that have no database statements in common. The training corpus of autoencoder 160 may consist of one of: database statements, sentence fingerprints, or encoded database statements. Like sentence fingerprints, encoded database statements are anonymous.

The training corpus of autoencoder 160 may be much smaller (i.e. fewer items) than the training corpus of artificial neural network 140, which accelerates training of autoencoder 160. Both training corpuses may be disjoint (i.e. non-overlapping) such that no database statement is duplicated in both corpuses or such that no sentence fingerprint is duplicated in both corpuses.

In an embodiment, the latent space of autoencoder 160 contains at most eighty dimensions, which conserves memory during operation of autoencoder 160. Herein, machine learning (ML) configuration of models and training tasks is adjustable with settings such as hyperparameters, and these adjustable settings may be manually or automatically tuned for an individual application, dataset, or environment.

### 2.0 Example Training and Inferencing Process

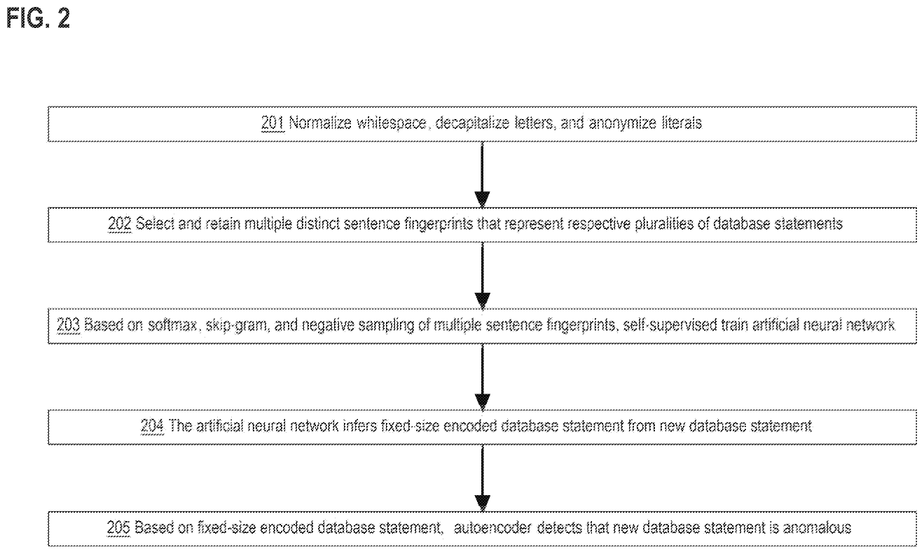

FIG. 2 is a flow diagram that depicts an example process that computer 100 may perform to train artificial neural network (ANN) 140 to infer encoded database statement 150 from sentence fingerprint 121 that represents database statement 111.

For each database statement in a text corpus of database statements, normalization step 201 normalizes whitespace, decapitalizes letters, and anonymizes literals as discussed earlier herein. The text corpus may be streamed through normalization step 201 and into next step 202.

Fingerprint corpus generation step 202 retains multiple sentence fingerprints that represent respective pluralities of similar database statements. Similarity of database statements is detected when the database statements have identical fingerprints generated by previous step 201. To generate the fingerprint corpus, one distinct fingerprint is retained for each plurality of similar database statements.

Fingerprint generation including duplicate fingerprints occurs during step 201. Selection and retention of distinct fingerprints occurs during step 202. In an embodiment, steps 201-202 are combined. After step 202, the text corpus may be discarded for privacy. For example, if the text corpus is streamed as discussed above, for privacy the stream might not be retained. Retention of the fingerprint corpus is sufficient for training as follows.

Based on a softmax, a skip-gram, and/or negative sampling of multiple sentence fingerprints, step 203 self-supervised trains artificial neural network 140. Softmax is a neural layer or network that provides accelerated inferencing. Skip-gram is a training objective that predicts tokens adjacent to a current token (e.g. word). Negative sampling entails randomly selecting a small subset of tokens that occur in the training corpus but never adjacent to the current word. Negative sampling accelerates training and increases accuracy. In an embodiment, step 203 uses a training objective function that uses data derived from the entire training corpus or uses the entire training corpus. In a BERT embodiment, the training objective may or may not be self-supervised masked language modeling (MLM) instead of skip-gram.

Self-supervised training is somewhat similar to unsupervised training, and both can use an unlabeled training corpus. Self-supervision in step 203 is based on negative sampling to generate true negatives and directly using the training corpus as true positives. Training step 203 may be independent of the downstream application such as anomaly detection. Step 203's positives and negatives are not necessarily anomalies or non-anomalies.

After step 203, artificial neural network 140 is already trained and/or fine tuned. In step 204, artificial neural network 140 infers a fixed-sized encoded database statement from a variable-sized new database statement. This may entail normalization activities similar to those of step 201, except that step 204 performs those activities only for the new database statement. That is, step 204 generates only one sentence fingerprint, which is the fingerprint of the new database statement.

Although earlier discussion of FIG. 1 includes database statements 111-113 in a training corpus for artificial neural network 140, in the following examples, any one of those database statements may instead be new, not in the training corpus, and not created until after training of artificial neural network 140.

For example if database statement 112 were new, then step 204 generates a new sentence fingerprint that is identical to sentence fingerprint 122, even though the training corpus contained sentence fingerprint 122 instead for other database statement 113. In another example, database statement 111 is new, and step 204 generates new sentence fingerprint 121 that, in this example, did not occur in the training corpus. In any case, step 204 makes no attempt to correlate the new database statement or new sentence fingerprint with anything in the training corpus.

Based on the fixed-size encoded database statement inferred by step 204, autoencoder 160 detects that the new database statement is anomalous or not anomalous in step 205. Step 205 is application specific as discussed earlier herein. In other embodiments, step 205 is replaced with a different downstream step for a different downstream application, and that replacement does not impact the implementation and performance of steps 201-204. For example, steps 201-204 may support downstream applications other than anomaly detection.

When step 205 detects that the new database statement is anomalous, the new database statement may be automatically specially processed such as discarded, logged, further analyzed, executed with restricted permissions, or alerted. Step 205 increases database security by preventing execution of an anomalous database statement that would waste computer resources or damage recorded data.

### 3.0 Exemplary Embodiment

This exemplary embodiment may be an implementation of any embodiment earlier herein. The following design choices of this exemplary embodiment can be combined with any embodiment earlier herein, but these design choices do not limit embodiments earlier herein.

Artificial neural network 140 may have an open source implementation such as FastText or BERT, and either may be obtained pretrained and then fine tuned as discussed earlier herein.

FastText is trained for 20 epochs (i.e. passes over the training corpus). The minimum count for a word or token to be added in a dictionary (i.e. corpus vocabulary) is ten. Encoded database statement 150 is a feature vector having a fixed size (i.e. capacity) of three hundred numeric features (i.e. elements or dimensions), and some embodiments may have less capacity.

Downstream anomaly detection training of autoencoder 160 entails learns to recognize sentence fingerprints of some new database statements as normal to the training corpus and detect that other new database statements (i.e. sentence fingerprints) are substantially different from the training corpus. Autoencoder 160 is a denoising autoencoder that consists of an neural encoder (that maps the input to a vector in a latent space) and neural decoder that (e.g. imperfectly) reconstructs the input (i.e. encoded database statement 150) from the vector in latent space. The training objective of autoencoder 160 is to minimize the reconstruction error. The latent space in autoencoder 160 has fewer dimensions than encoded database statement 150 has.

The components of FIG. 1 are contained in a database management system (DBMS) or database server. An anomalous database statement causes a high reconstruction error by autoencoder 160. If the reconstruction error is higher than a predefined threshold, then the database statement is inferentially classified as an anomaly.

Autoencoder 160 consists of three fully-connected rectified linear unit (RELU) neural activation layers in the encoder, and the decoder is similar. Autoencoder 160 is trained for fifty epochs with early stopping and stochastic gradient descent (SGD) optimization such as by Adam that is an adaptive optimizer.

The anomaly detection performance is evaluated quantitatively based on a fitness metric such as normalized discounted cumulative gain (NDCG). It is novel to use NDCG for anomaly detection training. NDGC is a relevance metric and, herein, malicious and high risk anomalies are more important (i.e. relevant) than low risk anomalies.

Zero shot learning is implemented. As discussed earlier herein, the training data for anomaly detection can be from a different source than that used to train artificial neural network 140. This is the case for zero shot transfer learning. Artificial neural network 140 is trained on a much larger corpus of SQL statements and the downstream anomaly detection model is trained on a distinct and much smaller corpus.

### 4.0 Database Overview

Embodiments of the present invention are used in the context of database management systems (DBMSs). Therefore, a description of an example DBMS is provided.

Generally, a server, such as a database server, is a combination of integrated software components and an allocation of computational resources, such as memory, a node, and processes on the node for executing the integrated software components, where the combination of the software and computational resources are dedicated to providing a particular type of function on behalf of clients of the server. A database server governs and facilitates access to a particular database, processing requests by clients to access the database.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database comprises data and a database dictionary that is stored on a persistent memory mechanism, such as a set of hard disks. A database is defined by its own separate database dictionary. A database dictionary comprises metadata that defines database objects contained in a database. In effect, a database dictionary defines much of a database. Database objects include tables, table columns, and tablespaces. A tablespace is a set of one or more files that are used to store the data for various types of database objects, such as a table. If data for a database object is stored in a tablespace, a database dictionary maps a database object to one or more tablespaces that hold the data for the database object.

A database dictionary is referred to by a DBMS to determine how to execute database commands submitted to a DBMS. Database commands can access the database objects that are defined by the dictionary.

A database command may be in the form of a database statement. For the database server to process the database statements, the database statements must conform to a database language supported by the database server. One non-limiting example of a database language that is supported by many database servers is SQL, including proprietary forms of SQL supported by such database servers as Oracle, such as Oracle Database 11g. SQL data definition language (“DDL”) instructions are issued to a database server to create or configure database objects, such as tables, views, or complex types. Data manipulation language (“DML”) instructions are issued to a DBMS to manage data stored within a database structure. For instance, SELECT, INSERT, UPDATE, and DELETE are common examples of DML instructions found in some SQL implementations. SQL/XML is a common extension of SQL used when manipulating XML data in an object-relational database.

A multi-node database management system is made up of interconnected nodes that share access to the same database. Typically, the nodes are interconnected via a network and share access, in varying degrees, to shared storage, such as with shared access to a set of disk drives and data blocks stored thereon. The nodes in a multi-node database system may be in the form of a group of computers, such as work stations and/or personal computers, that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### 4.1 Query Processing

A query is an expression, command, or set of commands that, when executed, causes a server to perform one or more operations on a set of data. A query may specify source data object(s), such as table(s), column(s), view(s), or snapshot(s), from which result set(s) are to be determined. For example, the source data object(s) may appear in a FROM clause of a Structured Query Language (“SQL”) query. SQL is a well-known example language for querying database objects. As used herein, the term “query” is used to refer to any form of representing a query, including a query in the form of a database statement and any data structure used for internal query representation. The term “table” refers to any source object that is referenced or defined by a query and that represents a set of rows, such as a database table, view, or an inline query block, such as an inline view or subquery.

The query may perform operations on data from the source data object(s) on a row by-row basis as the object(s) are loaded or on the entire source data object(s) after the object(s) have been loaded. A result set generated by some operation(s) may be made available to other operation(s), and, in this manner, the result set may be filtered out or narrowed based on some criteria, and/or joined or combined with other result set(s) and/or other source data object(s).

A subquery is a portion or component of a query that is distinct from other portion(s) or component(s) of the query and that may be evaluated separately (i.e., as a separate query) from the other portion(s) or component(s) of the query. The other portion(s) or component(s) of the query may form an outer query, which may or may not include other subqueries. A subquery nested in the outer query may be separately evaluated one or more times while a result is computed for the outer query.

Generally, a query parser receives a query statement and generates an internal query representation of the query statement. Typically, the internal query representation is a set of interlinked data structures that represent various components and structures of a query statement.

The internal query representation may be in the form of a graph of nodes, each interlinked data structure corresponding to a node and to a component of the represented query statement. The internal representation is typically generated in memory for evaluation, manipulation, and transformation.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

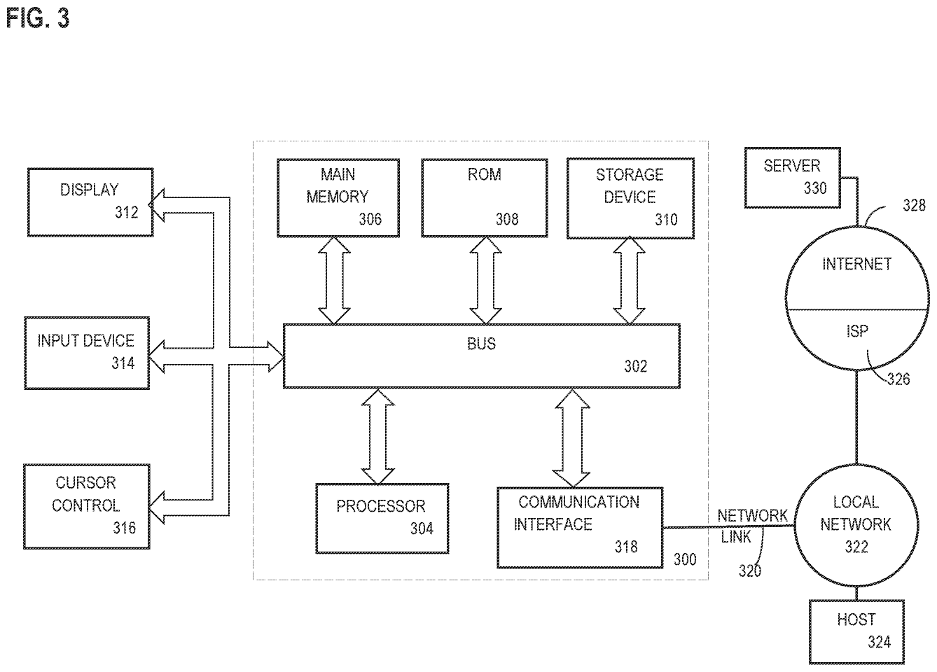

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

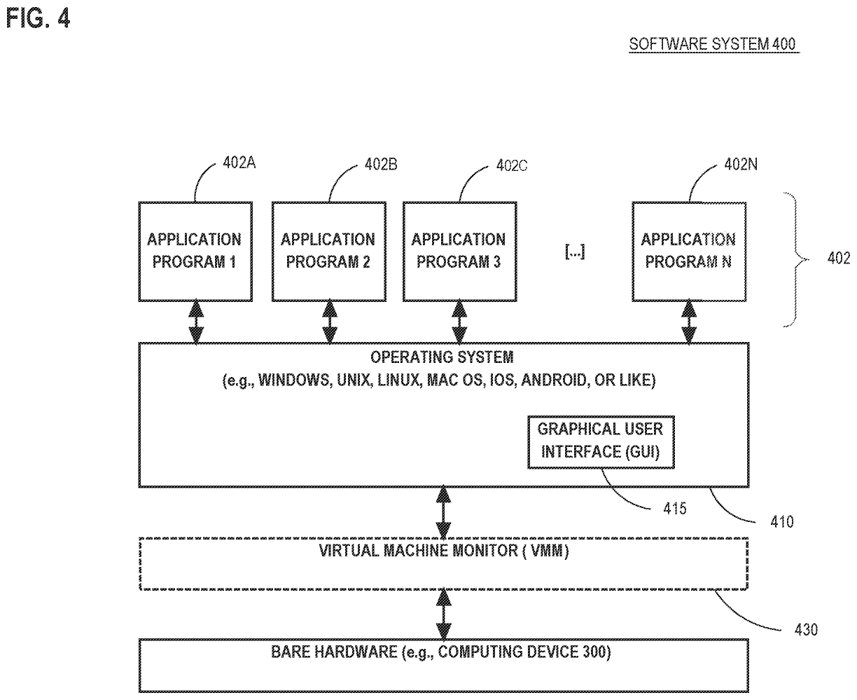

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 300 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N [L−1] and N [L], respectively, the dimensions of matrix W is N [L−1] columns and N [L] rows.

Biases for a particular layer L may also be stored in matrix B having one column with N [L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2 (1): 1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating a sentence fingerprint that represents a plurality of database statements;
training, based on the sentence fingerprint that represents the plurality of database statements, an artificial neural network;
inferring, by the artificial neural network, a fixed-size encoded database statement from a new database statement; and
detecting, based on the fixed-size encoded database statement, that the new database statement is anomalous.

2. The method of claim 1 wherein said generating the sentence fingerprint that represents the plurality of database statements comprises normalizing whitespace, decapitalizing letters, and anonymization.

3. The method of claim 1 wherein said anonymization comprises replacement of all literal values with a same predefined token.

4. The method of claim 1 wherein said training the artificial neural network comprises a vocabulary of at most a thousand tokens.

5. The method of claim 1 wherein:
said training the artificial neural network is based on a first unlabeled training corpus;
the method further comprises training an autoencoder to detect anomalies in a second unlabeled training corpus that is smaller than the first unlabeled training corpus.

6. The method of claim 5 wherein the autoencoder has a latent space that contains at most eighty dimensions.

7. The method of claim 5 wherein the first unlabeled training corpus does not contain the second unlabeled training corpus.

8. The method of claim 1 wherein the artificial neural network comprises none of: an autoencoder, a recurrent neural network, and a long short-term memory.

9. The method of claim 1 wherein said training the artificial neural network comprises using at least one selected from a group consisting of negative sampling, a softmax, and a skip-gram.

10. The method of claim 1 wherein said training the artificial neural network is based on an entire training corpus that is unlabeled and an objective function that is based on the entire training corpus.

11. The method of claim 10 wherein the entire training corpus consists of database statements or sentence fingerprints that represent database statements.

12. The method of claim 1 wherein:
the method further comprises generating a second database statement fingerprint that represents a second plurality of database statements;
said training the artificial neural network is further based on the second database statement fingerprint.

13. The method of claim 1 wherein the fixed-size encoded database statement is a numeric vector that contains at most three hundred dimensions.

14. One or more machine-readable non-transitory media storing instructions that, when executed by one or more processors, cause:
generating a sentence fingerprint that represents a plurality of database statements;
training, based on the sentence fingerprint that represents the plurality of database statements, an artificial neural network;
inferring, by the artificial neural network, a fixed-size encoded database statement from a new database statement; and
detecting, based on the fixed-size encoded database statement, that the new database statement is anomalous.

15. The one or more machine-readable non-transitory media of claim 14 wherein said generating the sentence fingerprint that represents the plurality of database statements comprises normalizing whitespace, decapitalizing letters, and anonymization.

16. The one or more machine-readable non-transitory media of claim 14 wherein said anonymization comprises replacement of all literal values with a same predefined token.

17. The one or more machine-readable non-transitory media of claim 14 wherein said training the artificial neural network comprises a vocabulary of at most a thousand tokens.

18. The one or more machine-readable non-transitory media of claim 14 wherein:
said training the artificial neural network is based on a first unlabeled training corpus;
the instructions further cause training an autoencoder to detect anomalies in a second unlabeled training corpus that is smaller than the first unlabeled training corpus.

19. The one or more machine-readable non-transitory media of claim 18 wherein the autoencoder has a latent space that contains at most eighty dimensions.

20. The one or more machine-readable non-transitory media of claim 14 wherein the fixed-size encoded database statement is a numeric vector that contains at most three hundred dimensions.
